(19) United States
(12) Patent Application Publication
(10) Pub. No.: US 2014/0019252 A1
(43) Pub. Date: Jan. 16, 2014

(54) Methods and Apparatus for Managing a Content Stream

(71) Applicant: Ford Global Technologies, LLC, Dearborn, MI (US)

(72) Inventors: Perry Robinson MacNeille, Lathrup Village, MI (US); Oleg Yurievitch Gusikhin, West Bloomfield, MI (US); Gary Steven Strumolo, Canton, MI (US); Basavaraj Tonshal, Northville, MI (US)

(73) Assignee: Ford Global Technologies, LLC, Dearborn, MI (US)

(21) Appl. No.: 14/036,336

(22) Filed: Sep. 25, 2013

Related U.S. Application Data
(62) Division of application No. 13/185,975, filed on Jul. 19, 2011.

(51) Int. Cl. G06Q 30/02

(52) U.S. Cl. CPC G06Q 30/0265
USPC 705/14.62

(57) ABSTRACT

A computer-implemented method includes receiving a request for media playback sent from a vehicle computing system (VCS) and aggregating a plurality of user, environmental and vehicle data elements for at least one known consumer in a vehicle to receive media. The embodiment also includes requesting media plans from a plurality of media provision sources, the plan based at least in part on the aggregated user, environmental and vehicle data elements. The method further includes reviewing the media plans to select a plan received responsive to the request that best corresponds to the user, environmental and vehicle data elements. Also, the method includes sending the selected plan to the VCS for playback.

### CROSS-REFERENCE TO RELATED APPLICATIONS

This application is a division of U.S. application Ser. No. 13/185,975 filed Jul. 19, 2011, the disclosure of which is hereby incorporated in its entirety by reference herein.

### TECHNICAL FIELD

The illustrative embodiments generally relate to methods and apparatus for managing a content stream.

### BACKGROUND

Numerous sources of “infotainment” are available in a streaming and/or on-demand fashion. What originally began as radio broadcasts and records has evolved into digital content, and under the modern paradigm users can specifically tailor custom music streams that fit their specific listening desires.

Internet radio, “smart” music streaming, such as PANDORA, and specific requested content are all forms of modern audio entertainment, and with portable digital video systems, movies and television shows may also be included under the general concept of “infotainment” in a present sense.

Typically, when using a “smart” streaming service such as PANDORA, a user will have a variety of preferences associated with a user identity. Based on these preferences, and feedback gathered with respect to delivered content, the delivery service will attempt to provide music that is custom tailored to the audio preferences of the user.

Additionally, because traditional mediums such as radio, which includes advertisements, are somewhat diminished in popularity due to consumer-tailored content delivery, advertisers must seek out new mediums over which advertisements can be delivered.

### SUMMARY

In a first illustrative embodiment, a computer-implemented method includes receiving a request for media playback sent from a vehicle computing system (VCS) and aggregating a plurality of user, environmental and vehicle data elements for at least one known consumer in a vehicle to receive media.

The illustrative embodiment also includes requesting media plans from a plurality of media provision sources, the plan based at least in part on the aggregated user, environmental and vehicle data elements. The illustrative method further includes reviewing the media plans to select a plan received responsive to the request that best corresponds to the user, environmental and vehicle data elements. Also, the illustrative method includes sending the selected plan to the VCS for playback.

In a second illustrative embodiment, a computer-implemented method includes receiving a request relating to an advertisement played in conjunction with a media stream. The illustrative method further includes storing, with respect to a requesting user's profile, information relating to the media stream and advertisement. The illustrative method additionally includes analyzing stored information to determine future potential schema for delivery of media and advertising content.

In a third illustrative embodiment, a computer readable storage medium stores instructions that, when executed, cause a processor to perform the method including receiving a request for media playback sent from a vehicle computing system (VCS). The illustrative method also includes aggregating a plurality of user, environmental and vehicle data elements for at least one known consumer in a vehicle to receive media and requesting media plans from a plurality of media provision sources, the plan based at least in part on the aggregated user, environmental and vehicle data elements.

Also, this illustrative method includes reviewing the media plans to select a plan received responsive to the request that best corresponds to the user, environmental and vehicle data elements. The illustrative method further includes sending the selected plan to the VCS for playback.

### BRIEF DESCRIPTION OF THE DRAWINGS

FIG. 1 shows an illustrative example of a vehicle computing system;

FIG. 2 shows an illustrative example of a media assembly and delivery system;

FIG. 3A shows an illustrative example of a process for content delivery;

FIG. 3B shows an illustrative example of a process for assembling content;

FIG. 3C shows an illustrative example of a process for data gathering;

FIG. 4A shows an illustrative example of an advertisement delivery process;

FIG. 4B shows an illustrative example of data collection process; and

FIG. 4C shows an example of a data gathering and analysis process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

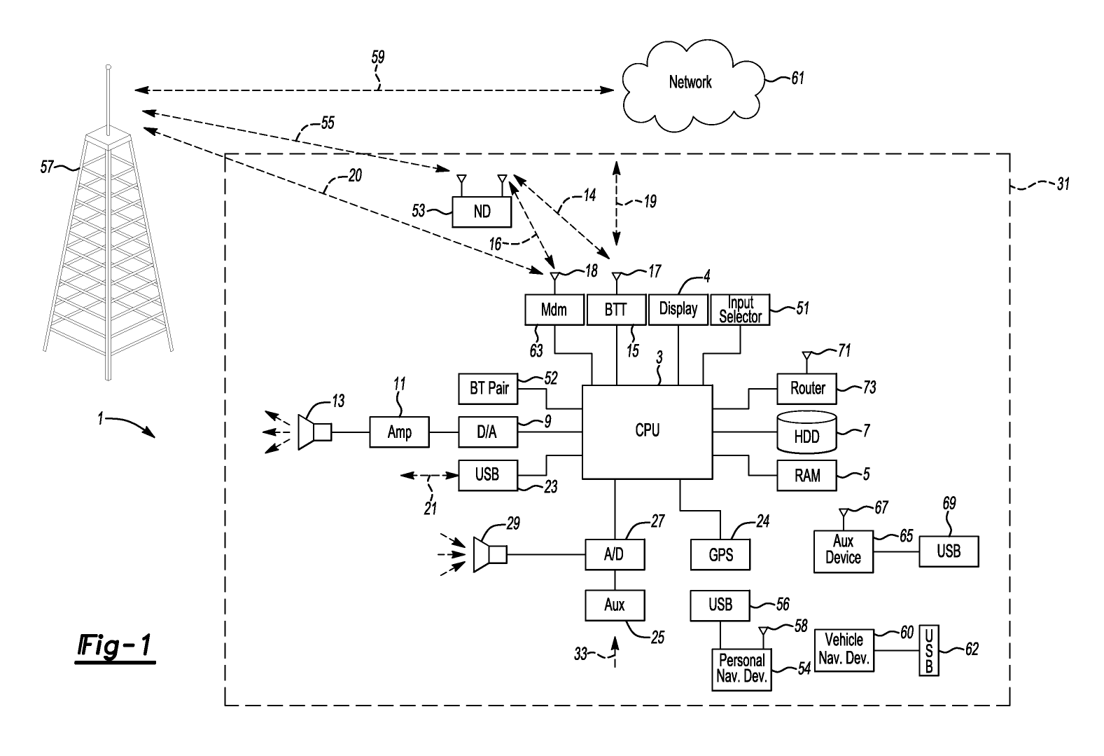

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

Although infotainment presentation devices exist in a multitude of forms in modern vehicles, there is no present model for capture of revenue stream by a vehicle manufacturer from advertisements associated with content delivery in place today. A media provider may be able to in-line advertisements with content delivery, but this revenue is typically not shared with a vehicle manufacturer.

The vehicle manufacturer, however, may have access to a much greater store of knowledge with respect to a particular consumer, and may be able to add value to selection of particular advertisement delivery. Of course, a large portion of the incentive to do so would come from the manufacturer's ability to subsequently share in the advertising revenues.

At the same time, the manufacturer may wish to ensure that a safe driving environment is maintained, and that the infotainment system provided in a vehicle is not compromised by content that may detract from the driving experience. The illustrative embodiments present a concept that addresses this situation.

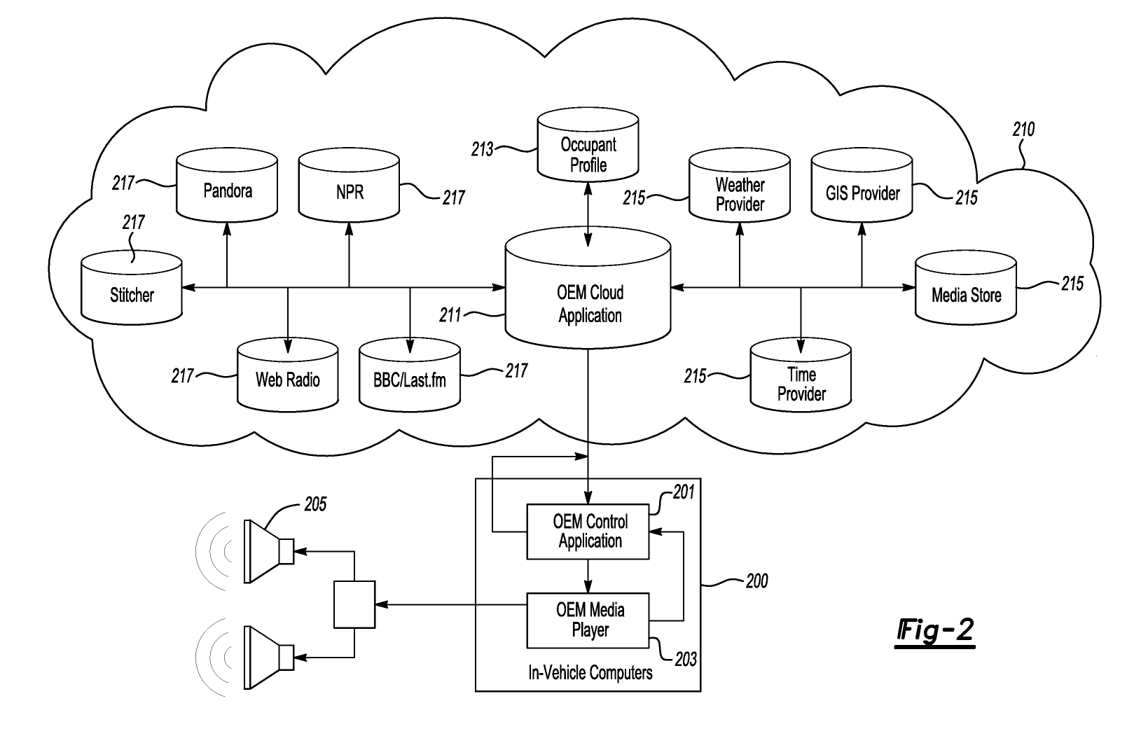

FIG. 2 shows an illustrative example of a media assembly and delivery system. In one illustrative example, the solution has three hardware/software components: 1) a control application that runs in the vehicle 201; 2) an informational filter that runs in the cloud 211; and 3) a media player 203 that runs on a head unit of the sound system or other infotainment delivery system.

The control application may gather information from an occupant 213 that is usable in determining a media selection, anonymize the information to protect the privacy of the occupant, and then forward the information to a filter in the cloud 211. The filter can select a next media track for delivery based on the information and deliver the track to the vehicle.

In addition to occupant information, vehicle data may also be gathered (such as, but not limited to, location, speed, driver's weight, cognitive load, driving aggression, etc.). This information can be used in conjunction with historic driver information to select media advertisements specifically tailored to a driver's situation. Advertisements tailored to the driver can then be delivered as needed to offset costs incurred by the manufacturer in developing the media play system.

Additional information about a driver's environment may also be gathered from cloud-based sources 210. Used in conjunction with historical data, for example, it may be discovered that a particular person likes certain types of music in the rain, and is responsive to different types of advertisements in different weather conditions.

Media information can be sent to a variety of sources 217, and then, based on filters, occupant data, and historical data, the cloud application 211 can pick a returned playlist most likely to please all occupants of the vehicle.

Since information can be obtained on all occupants of the vehicle, playlists can be tailored to include media enjoyable by all vehicle occupants.

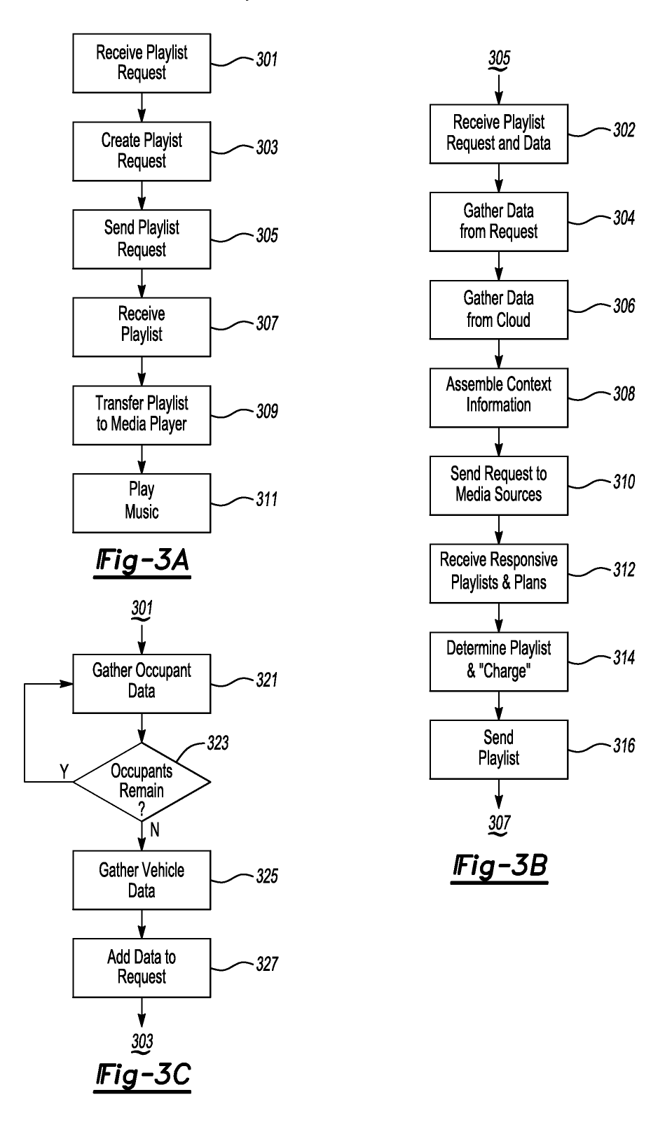

FIG. 3A shows an illustrative example of a process for content delivery. In this illustrative embodiment, a vehicle computing system (VCS) receives a request from an occupant to provide a media playlist 301. In response to the request, the VCS can create a playlist request to be sent to a cloud-based filter 303. Included with the request can be data relating to vehicle occupants, or at least data identifying vehicle occupants so that data relating to the occupants can be retrieved from cloud based storage if it isn't stored locally on the vehicle.

The playlist request is then sent with any included data to the cloud 305, and a playlist is received in return 307. This playlist is transferred to a media player 309, and the content thereof is replayed for the vehicle occupants 311.

FIG. 3B shows an illustrative example of a process for assembling content. On the cloud-side of the system, the playlist request 305 is received in the cloud, along with any data relating to the vehicle occupants 302. Data included with the request is removed for storage and/or processing 304.

In addition to data sent with the playlist request, other data may be gathered from the cloud itself 306. For example, without limitation, data relating to known vehicle passengers indicating historic preferences in music and advertising may be gathered from a remote source. Also, vehicle location data, time of day data, weather data, etc. may be gathered from cloud-based sources.

The data gathered from the cloud can be compared to historic occupant data to assemble a likely desired list of content or at least a context on which content assembly can be based 308. The assembled and filtered request may then be sent to a plurality of media sources in order to have playlists generated 310. In this embodiment, the media sources return both a suggested playlist and one or more advertisements to be included with the playlist. These advertisements provide the revenue for both the vehicle manufacturer and the media provider.

In a second embodiment, it may be the case that only a playlist of entertainment media is returned, without advertising media. In these instances, a cloud-based application can also generate one or more advertisement selections to be included with the media and delivered as part of the content stream.

Responsive to the request from the cloud-based application, the media sources generate their own particular playlists and return a playlist and/or content delivery plan including advertising 312. Based on the suggested advertising in the playlist, and a manufacturer determined “cost” for playlist playback, a charge may be determined 314. This can correspond to a particular number of advertisements, or a total revenue to be sent to the manufacturer. For example, if the charge is $0.10, sufficient advertisements may be played to generate $0.10 for the manufacturer. The playlist, media and any advertisements may then be delivered to the VCS 316 for processing.

FIG. 3C shows an illustrative example of a process for data gathering. This is an exemplary process that may be performed, for example, prior to sending a playlist request to the cloud for processing and filtering.

In this illustrative embodiment, a playlist request is received at the VCS 301. The VCS then collects information about a first vehicle occupant 321. The VCS may know who is in a vehicle through a variety of methods. The presence of particular wireless devices can indicate the presence of particular occupants, and the wireless devices may even contain occupant data/preferences that can be obtained from the devices by the VCS. Also, vehicle cameras, weight sensors, and other methods can be used to determine particular occupants, and whether any local data is saved with respect to the particular occupants.

Once data on a first occupant is obtained, the VCS may determine if any other occupants remain for whom data is to be gathered 323. Once all occupant data has been obtained, vehicle data may also be gathered 325. Some of the data may be obtained from the cloud, but vehicle data such as GPS position, speed, etc. may be gathered locally at the vehicle, if the proper sensing systems exist.

The data relating to both the vehicle and the occupants can then be added to the playlist request 337 to be sent to the cloud along with the playlist request.

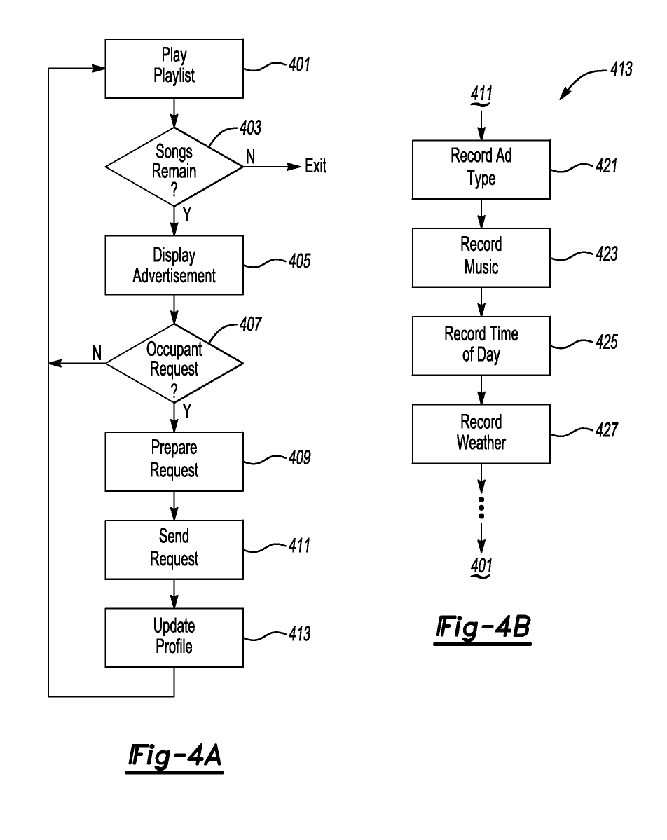

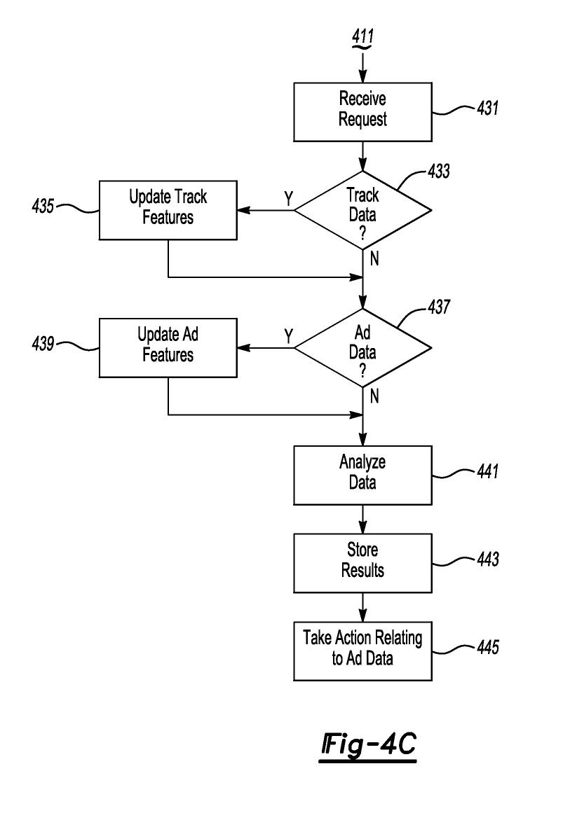

FIG. 4A shows an illustrative example of an advertisement delivery process. In this exemplary process, the vehicle occupant is given an opportunity to respond to an advertisement. The response could include, but is not limited to, purchase of a displayed item, a request for more information now on a displayed item (e.g., an extended media piece about the displayed/advertised item could be played), a request for more information later (i.e., an email sent to an associated account), an expression of no interest in the displayed item or similar items, etc.

In this illustrative example, the VCS plays the songs listed on the playlist 401. As long as at least one song remains 403, and advertisement may also be available for playback 405. Advertisements may be played according to a pre-determined plan, or randomly throughout a selection. It is not necessarily the case that the playback goes song, advertisement, song, etc.

In this illustrative example, the occupant is given an opportunity to respond to playback of an advertisement 407. In at least one example, the vehicle is outfitted with a touch-responsive display, allowing the occupant to input a response to a particular advertisement.

In one instance, the occupant may request purchase of an advertised item. This response can then be processed at the cloud, and may, for example, use a credit card and shipping address associated with a profile to purchase and deliver the item. Or the occupant can manually or verbally input payment/shipping details. In at least one embodiment, if a driver is the sole occupant, input of payment and shipping details through a touch screen may be prevented until the vehicle is in a parked state.

In another example, the occupant may request more information on the item. It is possible that extended information data, such as specifications or a longer commercial, may be included with the media stream sent to a vehicle. In an instance such as this, a request for more information may result in play or presentation of the additional information.

In another example, the additional information may need to be requested from the cloud. In this case, the system may continue playing songs while the information is obtained and then, for example, play the information as a next advertisement.

In still a further example, the occupant may request that the information be delivered to an alternative source, such as a text message or email source. In this case, the system may request that a cloud-based application send the requested information to the indicated source.

If a request of any type is received in response to an advertisement, the VCS may prepare a relevant request 409 to be sent to the server 411. Additionally, in this example, data relating to the requesting user, the music playing, the time of day, etc. may be gathered and saved in conjunction with a user profile 413. The storage of this data may also be done remotely, as opposed to locally, such that the data can be accessed from the cloud at any time needed.

FIG. 4B shows an illustrative example of data collection process. Since the user has responded in some form to an advertisement at this point in the process, it may be useful to determine what the vehicle environment was during successful presentation of the advertisement. This information can then be used in the future to select similar advertising to be played under similar circumstances, with the hope of generating better advertising results and minimizing user disturbance by delivering advertisements that may be positively received by the user.

In this process, an advertisement type (and any other relevant data about the successful advertisement) is recorded for archiving 421. Information relating to the music 423, time of day 425, weather 427 and other possibly relevant factors is also recorded. This information can then be stored locally with respect to the profile of one or more occupants, or can be stored remotely so that cloud-based services can access the data when needed.

FIG. 4C shows an example of a data gathering and analysis process. In this particular embodiment, the cloud-based process is analyzing data generated through the result of user responses to advertisements in order to deliver better-tailored content to a user.

The cloud-based system receives a request from a user pertaining to a particular advertisement 431. Included with the request may be the previous track or tracks that were played as part of the playlist, and any data gathered or known by the vehicle relating to either occupants of the vehicle or the vehicle environment.

In this illustrative example, the process checks to see if data is available relating to a track or tracks of media that recently played in the vehicle (e.g., just prior to advertisement interaction) 433. If track data is available, the process will store data relating to the tracks 435, which may possibly indicate which songs place a vehicle occupant in a buying mood in general or for a particular product or type of products.

Also, there is a determination if any data relating to the particular advertisement itself is available 437. Advertisement data can be stored 439, and using this data it can be determined what types of advertisements the user is inclined to be responsive to while driving. The advertisement data can also be cross-linked to track, vehicle, and occupant data to determine the best possible environment for delivery of that advertisement again or similar advertisements.

The stored data may then be analyzed by the remote process to determine defining characteristics that could help indicate preferable future content 441. For example, without limitation, the data could be compared to previous analysis to see if the results from the present analysis are consistent with observed behavior. The more commonly confluences appear, the easier it will be to tailor a media and advertising package that should be pleasing to the driver while at the same time maximizing revenues from advertisement.

The results of the newest analysis can then be stored in a remote location 443, so that they are accessible for future playlist/advertisement request processing. The remote cloud based system can then take any action necessary with respect to the user request provided in conjunction with the advertisement.

A multitude of data may be stored and gathered with respect to vehicle occupants, and used to determine both advertisement selection and playlist selection. For example, without limitation, data relating to beliefs, cultural influences, geographic regions of origin, language, target market segments, etc. may be stored with respect to media and advertisements, and much of this data can also be obtained or determined with respect to vehicle occupants and used to correlate media delivery.

Group data can also be used, such that if a particular occupant falls into a particular demographic, media preferred by that demographic can be played or presented and occupant response gauged. If the advertisement or entertainment is enjoyed or disliked, this data can be then used to tailor a profile for the occupant and update the demographic data.

Even more detailed information, such as local landscaping (mountain, plain, ocean, etc), particular narrators, time of day, mood of occupant, etc. can be used in tailoring media selections. This can allow on-time delivery of content determined over time to be the most preferred and effective given a very specific set of environmental triggers and preferences. Such content should be far more effective than the mere generic mass-delivery of generalized advertising.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer-implemented method comprising:
receiving a request relating to an advertisement played in conjunction with a media stream;
storing, with respect to a requesting user's profile, information relating to the media stream and advertisement; and
analyzing stored information to determine future potential schema for delivery of media and advertising content.

2. The method of claim 1, wherein the information relating to the media stream includes a song title.

3. The method of claim 1, wherein the information relating to the media stream includes a song type.

4. The method of claim 1, wherein the information relating to the media stream includes a song artist.

5. The method of claim 1, wherein the information relating to the advertisement includes a manufacturer or service provider.

6. The method of claim 1, wherein the information relating to the advertisement includes a product category.

7. The method of claim 1, wherein the information relating to the advertisement includes a product name.

8. The method of claim 1, wherein the analyzing includes comparing information relating to the media stream to information related to previous media streams when a request was made relating to previous advertisements played in conjunction with previous media streams.

9. The method of claim 1, wherein the analyzing includes comparing information relating to the advertisements with information relating to previous advertisements for which a request was made.

10. A system comprising:
a processor configured to:
receive a request relating to an advertisement played in conjunction with a media stream;
store, with respect to a requesting user's profile, information relating to the media stream and advertisement; and
analyze stored information to determine future potential schema for delivery of media and advertising content.

11. The system of claim 10, wherein the information relating to the media stream includes a song title.

12. The system of claim 10, wherein the information relating to the media stream includes a song type.

13. The system of claim 10, wherein the information relating to the media stream includes a song artist.

14. The system of claim 10, wherein the information relating to the advertisement includes a manufacturer or service provider.

15. The system of claim 10, wherein the information relating to the advertisement includes a product category.

16. The system of claim 10, wherein the information relating to the advertisement includes a product name.

17. The system of claim 10, wherein the processor is further configured to compare information relating to the media stream to information related to previous media streams when a request was made relating to previous advertisements played in conjunction with previous media streams.

18. The method of claim 7, wherein processor is further configured to compare information relating to the advertisements with information relating to previous advertisements for which a request was made.

19. A non-transitory computer-readable storage medium, storing instructions that, when executed by a processor, cause the processor to perform a method comprising:
receiving a request relating to an advertisement played in conjunction with a media stream;
storing, with respect to a requesting user's profile, information relating to the media stream and advertisement; and
analyzing stored information to determine future potential schema for delivery of media and advertising content.

20. The storage medium of claim 19, wherein the analyzing includes comparing information relating to the media stream to information related to previous media streams when a request was made relating to previous advertisements played in conjunction with previous media streams.
